(19) United States
(12) Patent Application Publication
(10) Pub. No.: US 2013/0340015 A1
(43) Pub. Date: Dec. 19, 2013

(54) METHOD FOR ACCESSING MULTIMEDIA CONTENT WITHIN A HOME

(71) Applicant: Erwann Magis, Paris (FR)

(72) Inventor: Erwann Magis, Paris (FR)

(73) Assignee: VIACCESS, Paris Ia Defense (FR)

(21) Appl. No.: 13/981,939

(22) PCT Filed: Jan. 23, 2012
(86) PCT No.: PCT/EP12/50933

§ 371 Date: Aug. 27, 2013

(30) Foreign Application Priority Data
Jan. 27, 2011 (FR) 1150635

(51) Int. Cl. H04N 21/436

(52) U.S. Cl. CPC H04N 21/43615
USPC 725/82

(57) ABSTRACT

A method for accessing multimedia contents within a household via a network includes causing a master to build a contents log associating each content with a server, seeking a multimedia content in the log, and setting up a unicast channel between the client and a server associated with the contents sought in the log, causing the client to receive, using the channel, the content, and to play back the content, in response to connection of a new client or server to the home network or disconnection of a master from the home network, causing different apparatuses capable of functioning as a referencing server to exchange criteria for electing an apparatus to function as a referencing server, and based on the criteria, electing a new master from among the apparatuses capable of fulfilling the referencing server function, wherein in response to election, the new master functions as a reference server.

The invention pertains to a method for accessing multimedia contents within a household and to apparatuses for implementing this method.

In this description, the term “multimedia content” more specifically designates an audio and/or video content to be rendered in a form directly perceptible to and understandable by a human being. A multimedia content is for example a film, a program of a television channel, a text designed for a digital book, music, or again an interactive content such as a game.

The increase in the number of multimedia apparatuses used in households has led manufacturers to develop a standard of interoperability better known as the DLNA (Digital Living Network Alliance). The DLNA standard enables the sharing of a multimedia content between different apparatuses or again the controlling of an apparatus independently of its make or nature. For example, when the apparatuses in a household are linked by a home network supporting the DLNA services, it is possible to take a photograph and view it immediately on a television set or again listen to music stored on a computer or on a HiFi system.

In this description, the term “DLNA-compatible” is understood to mean an apparatus capable of communicating by means of communications protocols defined in the DLNA standard. These communications protocols are WiFi, Ethernet or MoCA protocols for the physical layer, UpnP Device Architecture protocols for discovery and control, UPnP AV protocols for the management of multimedia contents, HTTP protocols for the transport layer and finally DTCP-IP protocols for the protection of multimedia contents during transport.

In this context, known households comprise:
a home network,
at least one apparatus that is a server of multimedia contents connected to the home network,
at least one client apparatus connected to the home network having the capacity to play back a multimedia content accessible through server apparatuses, and
a master apparatus, among the server or client apparatuses, that fulfils a referencing server function.

Methods, known to the filing party, for accessing a multimedia content within such households comprise the following steps:
the master apparatus builds a contents log of the multimedia contents stored or accessible through the different server apparatuses of the household, this contents log containing, for each multimedia content of a server apparatus of the household, at least one identifier of this multimedia content and one identifier of the server apparatus of this multimedia content,
a multimedia content is sought in this contents log and a unicast communications channel in the home network is set up between the client apparatus and the server apparatus the identifier of which is associated with the multimedia contents sought in this contents log, and
the client apparatus receives the multimedia content by means of the channel set up and plays back this multimedia content.

A method of this type is advantageous inasmuch as the client apparatuses, through the contents log, possess a complete view of the contents accessible within the household. Thus, a client apparatus wishing to access a multimedia content on the network, directly identifies the server apparatus through which a multimedia content sought from the contents log is accessible.

In the methods known to the filing party, the master apparatus is typically a computer. Thus, a user wishing to implement this method of access, is obliged to keep this computer constantly on. This is a drawback because, when the household is deprived of this computer, access to the desired multimedia content is made slower. Indeed, in this case, a client apparatus wishing to access a given multimedia content has to interrogate the server apparatuses one by one in turn until it reaches the server apparatus through which the desired multimedia content is accessible. Thus, when the number of server apparatuses increases, the time needed to reach the server apparatus and hence the time needed to make the connection between the client apparatus and the server apparatus also increases. This duration results in a waiting period for the user which must be minimized.

The invention seeks to overcome one or more of these drawbacks.

The invention thus pertains to a method for accessing multimedia contents within a household, this method comprising, in response to the connection of a new apparatus to the home network, or the disconnection of the master apparatus from the home network, of the following steps:
the exchanging between the different apparatuses, capable of fulfilling the referencing server function, of criteria for electing an apparatus to fulfill the function of referencing server,
the election of the master apparatus from among these apparatuses capable of fulfilling the referencing server function on the basis of the election criteria exchanged, and
the implementing, by the elected master apparatus, of the referencing server function.

The method presented here above is advantageous in that, when the network is deprived of the master apparatuses, the apparatuses connected to this network automatically, on the basis of predefined criteria, elect an apparatus capable of replacing the master apparatus. Thus, there is almost always an apparatus fulfilling the function of referencing server on the home network. Thus, the client apparatus has constant access to a contents log, thus minimizing the time needed to set up the connection between a client apparatus and a server apparatus offering the given multimedia content. This also makes it possible to maintain a unified view of the multimedia contents present in the household. This view is unified because it enables the multimedia contents present in all the server apparatuses to be consulted without any need to be concerned about the server apparatus through which they are accessible. On the contrary, when there is no referencing server, a client apparatus, at a given point in time, can have only one view of the multimedia contents present on only one of the server apparatuses. This view is then fragmented.

In addition, when a new apparatus gets connected to the network, the election of the master apparatus is again implemented in such a way that it is always the apparatus most capable of fulfilling the referencing server function, among the apparatuses connected to the network, that is the master apparatus.

Finally, since the master apparatus is elected from among apparatuses already connected to the network, the user does not have to invest in a new apparatus specifically dedicated to the function of referencing server.

The embodiments of this method may comprise one or more of the following characteristics:
the method also comprises:
   the transmission, by the master apparatus, of the contents log to all the client apparatuses of the household,
   the reception and storage, by the client apparatus of the household, of this contents log,
   the acquisition of a search request for searching for a multimedia content by any one of the client apparatuses of the household, and
   in response, a search by this client apparatus for the identifier of the server apparatus through which the multimedia content sought is accessible in the contents log stored in this apparatus
the method also comprises:
   the adding or eliminating of a multimedia content accessible on a server apparatus,
   immediately in response, the updating of the contents log by the master apparatus and the transmission by the master apparatus of this updating of the contents log to all the apparatuses of the household,
   the reception of this updating by the apparatuses of the household and the updating of their contents log on the basis of the updating received;
the updating transmitted by the master apparatus consists of a partial contents log containing only the identifier of the added or eliminated multimedia content and only the identifier of the server apparatus on which this multimedia content has been added or eliminated;
each contents log comprises a version number enabling the identification, from different contents logs, of the most recent one and the election of the new master apparatus is done only from among the apparatuses that are capable of fulfilling the referencing server function and have stored an update of the contents log comprising a version number corresponding to the most recent version number from among the version numbers available in the household;
the criteria for electing the new master apparatus include one or more criteria among the following: the computing capacity of an apparatus, the type of apparatus, the type of connection of the apparatus to the network, the version number of the contents log stored in this apparatus, a number randomly drawn by the apparatus;
the method comprises:
   the building, by the master apparatus, of a table of activity containing, for each server apparatus of the household, of a state indicator indicating whether the server apparatus is connected to or disconnected from the home network,
   the transmission, by the master apparatus, of the table of activity of all the client apparatuses, and
   the automatic filtering, by the client apparatus, as a function of the table of activity, of results of the search to eliminate, from these results, all the multimedia contents accessible from a server disconnected from the home network.

The embodiments of this method furthermore have the following advantages:
when each client apparatus keeps the contents log in memory, the client apparatus can directly, in its stored contents log, retrieve the identifier of a server apparatus without going through the master apparatus, thus further minimizing the duration needed to set up the connection between the client apparatus and the server apparatus,
when the contents log of each client apparatus is updated immediately after the addition or elimination of a multimedia content on a server apparatus, the risk of error when a client apparatus gets connected to a server apparatus to access a multimedia content is limited,
when the updating of the contents log consists of a partial contents log, the bandwidth needed to transmit these updates is minimized,
when the election of a new master apparatus is done solely from among the apparatuses that have stored the most recent update of the contents log, the new master apparatus definitely possesses an updated contents log, and
when the client apparatuses store a table of activity, the client apparatus gives a view of the multimedia contents really accessible on the network, thus making it possible to limit the number of unsuccessful consultation requests.

The invention also pertains to an information-recording carrier comprising instructions to implement the above method when these instructions are executed by an electronic computer.

An object of the invention is also a server apparatus of multimedia contents for the implementation of the above method, this apparatus being equipped with an electronic computer programmed to:
build a contents log of the multimedia contents stored or accessible through the different server apparatuses of the household, this contents log containing, for each multimedia content of a server apparatus of the household, at least one identifier of this multimedia content and one identifier of the server apparatus of this multimedia content,
set up a unicast communications channel in the home network with a client apparatus chosen to a multimedia content play back a sought multimedia accessible from this server apparatus,
transmit the multimedia content sought by means of the channel set up so that the client apparatus plays back this multimedia content.

The electronic computer is also programmed, in response to the connection of a new apparatus to the home network, or the disconnection of the master apparatus from the home network, to:
exchange between the different apparatuses, capable of fulfilling the referencing server function, criteria for electing an apparatus to fulfill the function of referencing server,
elect a master apparatus, from among these apparatuses, capable of fulfilling the referencing server function on the basis of the election criteria exchanged,
implement, through the elected master apparatus, the referencing server function on the basis of the election criteria exchanged.

An object of the invention is also a client apparatus for the implementation of the above method, wherein the client apparatus comprises an electronic computer programmed to:
set up a unicast communications channel in the home network with a server apparatus whose identifier is associated with a multimedia content sought in a contents log of multimedia contents stored or accessible by means of the different server apparatuses of the household,
receive the multimedia content sought by means of the channel set up and play back this multimedia content.

The electronic computer is also programmed, in response to the connection of a new apparatus to the home network, or the disconnection of a master apparatus from the home network, to:
exchange between the different apparatuses, capable of fulfilling the referencing server function, of criteria for electing an apparatus to fulfill the function of referencing server,
elect a master apparatus from among these apparatuses capable of fulfilling the referencing server function on the basis of the election criteria exchanged,
implement the referencing server function when it is elected as master apparatus.

The embodiments of these apparatuses may comprise the characteristic according to which the apparatus is DLNA-compatible.

### BRIEF DESCRIPTION OF THE DRAWINGS

Other features and advantages of the invention shall appear more clearly from the following description, made by way of an indication that is in no way exhaustive, with reference to the appended drawings, of which:

FIG. 1 is a schematic illustration of a household,

FIG. 2 is a schematic illustration of a multimedia contents table stored in a multimedia apparatus of the household of FIG. 1,

FIG. 3 is a schematic illustration of a table of activity stored in a multimedia apparatus of the household of FIG. 1,

FIG. 4 is a schematic illustration of a contents log stored in a multimedia apparatus of the household of FIG. 1,

FIG. 5 is a flowchart of a method of access to multimedia contents within the household of FIG. 1,

FIG. 6 is a flowchart of a phase for reading a multimedia content implemented in the method of FIG. 5,

FIG. 7 is a flowchart of a phase for eliminating a multimedia content implemented in the method of FIG. 5,

FIG. 8 is a flowchart of a phase for disconnecting a master apparatus implemented in the method of FIG. 5,

FIG. 9 is a flowchart of a phase for connecting an additional apparatus implemented in the method of FIGS. 5, and

FIG. 10 is a flowchart of a phase for disconnecting a server apparatus of multimedia contents that does not fulfill the referencing server function implemented in the method of FIG. 5.

In these Figures, the same references are used to designate the same elements.

### DETAILED DESCRIPTION OF THE INVENTION

Here below in this description, the characteristics and functions well known to those skilled in the art are not described in detail.

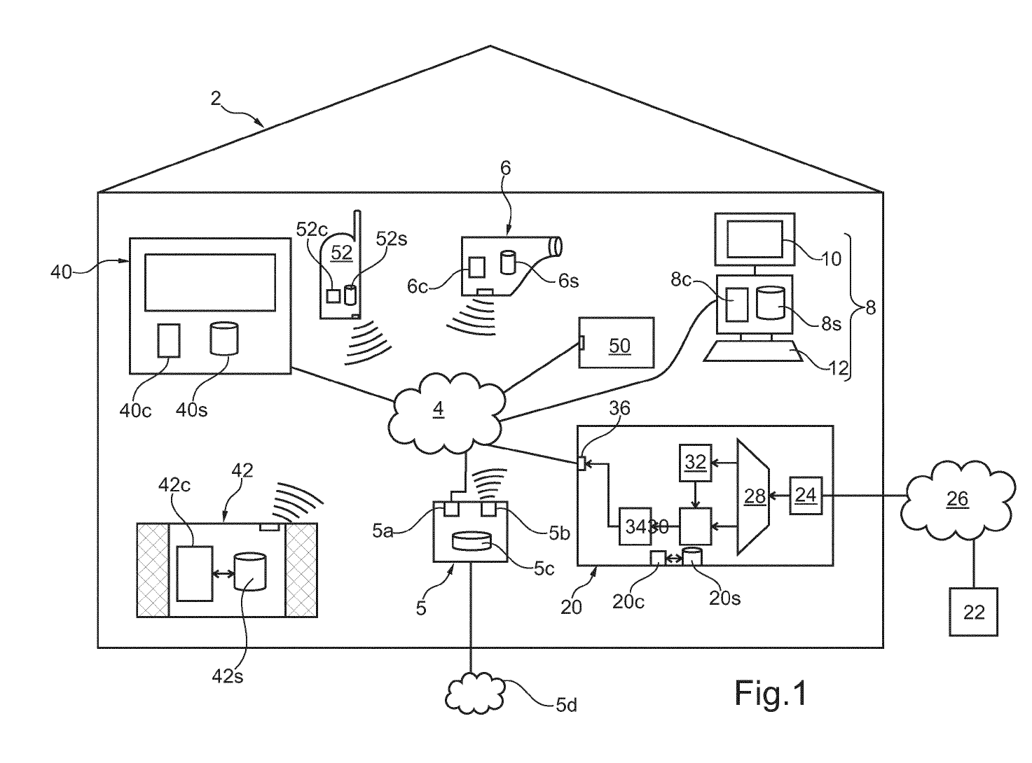

FIG. 1 illustrates a household 2. The household 2 is a private home such as a house or an apartment. This household 2 comprises:
a home network 4,
several multimedia apparatuses connected to the network 4, and
a router 5 to enable the multimedia apparatuses to communicate with one another within the household 2.

Generally, the household 2 has no other router than the router 5. The network 4 is a local area network.

The router 5 is for example the one implemented within an ADSL (Asymmetric Digital Subscriber Line) box of an internet service provider. Typically, this router 5 connects the network 4 to the World Wide Web 5d better known as the Internet.

The router 5 has a wire connection interface 5a. For example, the interface 5a has RJ45 ports to implement an Ethernet type network. The router 5 also has a wireless connection interface 5b. Here, the interface 5b is a WiFi transmitter. The router 5 finally has a memory 5c.

In this description, the term “multimedia apparatus” designates a pack or box within which there is implanted a set of computer, audiovisual and/or telecommunications means used to create, modify, consult, disseminate and/or archive a multimedia content.

Each multimedia apparatus of the household 2 comprises:
an information-recording carrier,
an electronic computer capable of executing instructions recorded in this information-recording carrier, and
a connection interface to connect the multimedia apparatus to one of the interfaces 5a or 5b of the router 5.

By convention, in this description, the computers and information-recording carriers of an apparatus referenced X are respectively referenced Xc and Xs.

Each recording carrier Xs contains an identity table. This table comprises the characteristics of the apparatus X. For example, this table comprises:
an identifier IDeq which uniquely identifies the multimedia apparatus X from among the multimedia apparatuses of the household 2,
the type of multimedia apparatus X,
the computing capacity of the computer Xc (expressed by a maximum number of elementary operations executable per second by the computer Xc of the multimedia apparatus X),
the type of connection (Ethernet or WiFi), and
the connection bit rate between the apparatus and the router (expressed in bits per second).

The type of apparatus is an indication of the membership of this apparatus in a category of a predefined list of categories. The type of apparatus is therefore an identifier of the category to which it belongs. Here, the list contains for example at least three categories: computer, cellphone, camera, etc.

The type of connection indicates whether the apparatus is connected to the network 4 by a wire link (for example Ethernet) or wireless link (for example WiFi).

Each recording carrier Xs also contains:
a table of activity, and
a contents log of the multimedia contents which can be accessed through different server apparatuses of the household 2.

These tables are described in greater detail with reference to FIGS. 3 and 4.

Of the multimedia apparatuses connected to the network 4, some are capable of fulfilling the function of referencing server. The referencing server function consists in:
building and updating the contents log, and
transmitting the contents log built and its updates to all the multimedia apparatuses of the household 2.

Here, the referencing server function consists additionally in:
building and updating the table of activity, and
transmitting the table of activity built and its updates to all the multimedia apparatuses of the household 2.

The recording carrier Xs of a multimedia apparatus capable of fulfilling the referencing server function contains specific instructions to be executed by the computer Xc in order to fulfill this function. In this example, all the multimedia apparatuses of the household 2 are capable of carrying out the referencing server function.

However, at a given point in time, at most one of these apparatuses effectively carries out the referencing server function. This apparatus is called a “master apparatus”.

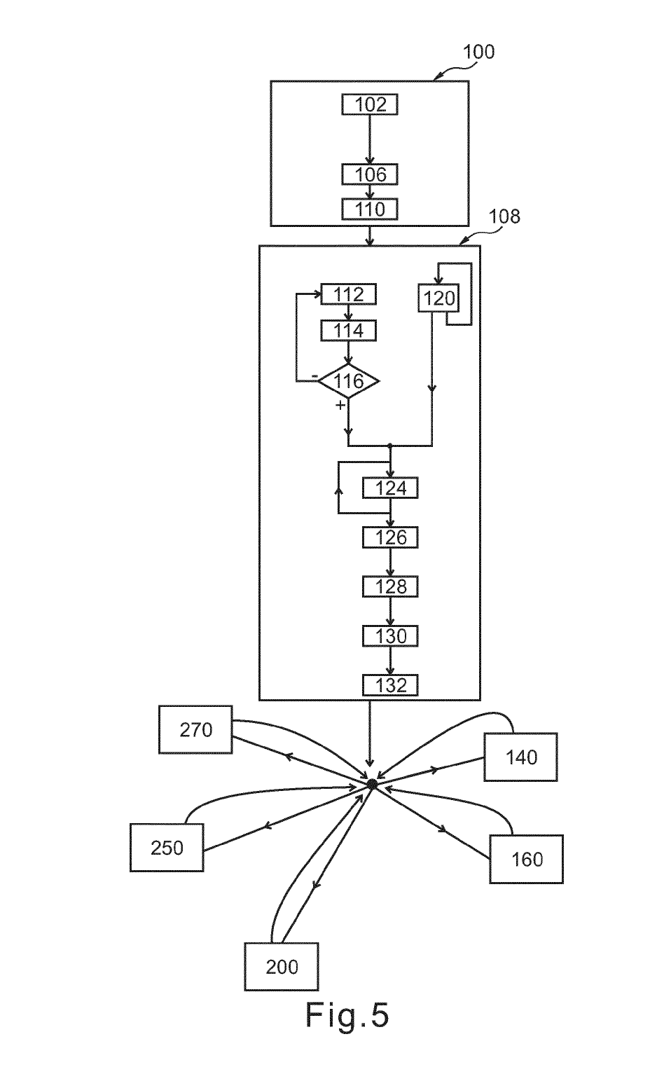

Finally, each recording carrier Xs contains the instructions to implement the method of FIG. 5.

Each multimedia apparatus performs at least one of the following roles:
the role of server apparatus of multimedia contents providing access to multimedia contents,
the role of client apparatus capable of playing back a multimedia content to which access is provided by one of the server apparatuses,
the role of proxy server through which there travels a multimedia content transmitted between a server apparatus and a client apparatus, and
the role of control apparatus to link together the apparatuses connected to the network 4.

A same multimedia apparatus can perform several of these roles.

Preferably, the household 2 has several server apparatuses. The server apparatus is programmed to store or make accessible a multimedia content and transmit it to a client apparatus connected to the network 4. Typically, when it does not store the multimedia content, the apparatus makes accessible a multimedia content received through a network external to the household 2. For example, in this case, the multimedia content is a television channel broadcast by a transmitter situated outside the household 2. Here, the server apparatuses transmit the multimedia content in a streaming mode. The term “streaming mode” designates a mode of transmission of a multimedia content in which the client apparatus can play back the multimedia content as and when it receives it. Streaming can be distinguished from file downloading. In the downloading of files, the client apparatus first receives all the packets constituting the multimedia content before it can start playing back this multimedia content. In streaming, the packets are received in the order in which they are transmitted. Thus, the playing back of a multimedia content can start before all the packets that constitute it are received. To this end, all the packets take the same route in the network 4. A pre-established routing table is therefore built and used by the server apparatus.

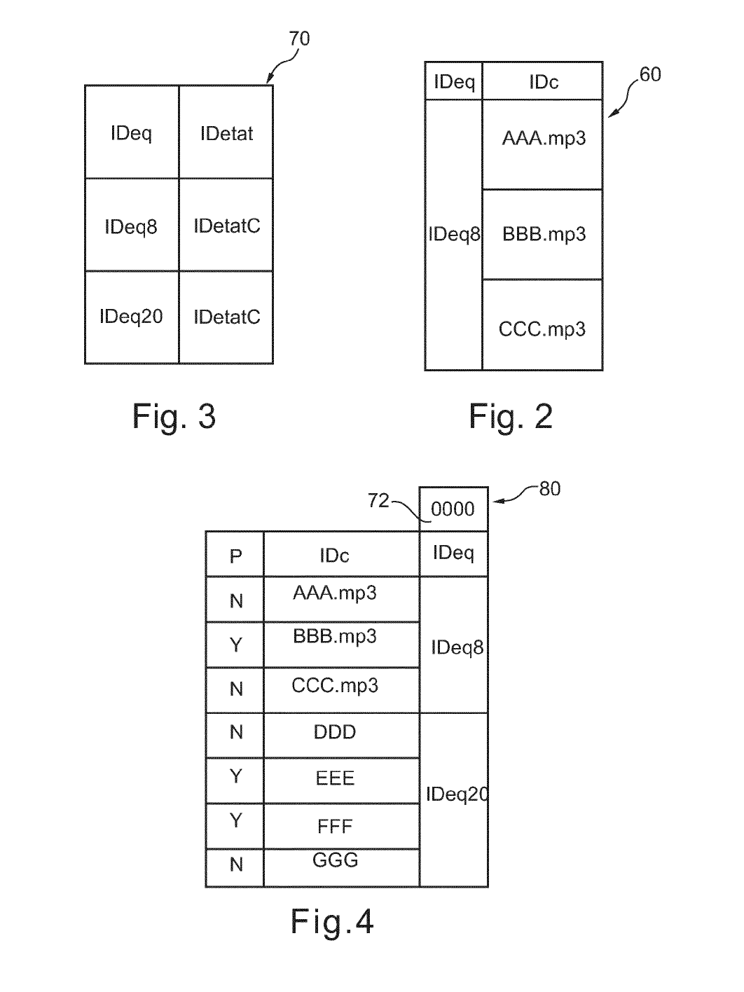

Each server apparatus has a table of multimedia contents proper to this server apparatus. This table lists the multimedia contents accessible to the client apparatuses from this server apparatus. A table of multimedia contents of a server apparatus is described further below with reference to FIG. 2.

In this embodiment, the server apparatuses comprise:
a camera 6,
a computer 8 equipped with peripherals such as a screen 10, and a keyboard 12, and
a terminal 20 for access to multimedia contents broadcast on external networks.

Multimedia contents are recorded on the information-recording carriers 6s and 8s. In the example, these carriers 6s and 8s are hard disk drives. Preferably, the memory space of these carriers is greater than or equal to 2 Gb, 20 Gb, 60 Gb, 100 Gb, or 1 Tb.

The terminal 20 enables access to television programs broadcast by a transmitter 22. Here, the terminal 20 also makes it possible to control access to scrambled multimedia contents. The terminal 20 is more commonly called a decoder or set-top box.

In the example, the terminal 20 comprises a receiver 24. The receiver 24 is connected to the transmitter 22 by means of a network 26 external to the household 2. The network 26 is typically a long-distance information transmission network such as a satellite network or any other broadcasting network such as the one used for the transmission of digital terrestrial television (DTTV).

The receiver 24 is connected to the input of a demultiplexer 28 which transmits, on the one hand, the signal received by the receiver to the descrambler 30 and, on the other hand, ECMs (Entitlement Control Messages) and EMMs (Entitlement Management Messages) to a security processor 32.

The security processor 32 decrypts a cryptogram CW* of a control word CW contained in an ECM and gives this control word to the descrambler 30. The descrambler 30 descrambles the scrambled multimedia content by means of the transmitted control word CW. The multimedia content is therefore descrambled only if the processor 32 possesses the cryptographic key enabling it to correctly decrypt the cryptogram CW* and, generally, if it is furthermore entitled to do so. For further information on the working of conditional access systems, the reader may refer to the following document: “Functional Model of Conditional Access System”, EBU Review, Technical European Broadcasting Union, Brussels, BE, n° 266, 21 Dec. 1995. The descrambled multimedia content is decoded by a decoder 34. For example, the decoder 34 decodes in accordance with the MPEG4 (Moving Picture Expert Group—4) standard and the multiplex coming from a DVB-S, DVB-T or DVB-C signal. Finally, the decoder is connected to a connection interface 36 which connects the terminal 20 to the router 5 by means of a wire link.

A client apparatus comprises at least one man/machine interface so as to be able to read or play back a multimedia content accessible through one of the server apparatuses. A man/machine interface is for example a screen or a speaker. In the example, the client apparatuses comprise a television set 40, a hi-fi system 42 and a cellphone 52. The apparatuses 6 and 8 are also capable of fulfilling their client apparatus function in addition to the server apparatus function.

A proxy server apparatus enables the conversion of the original format of a multimedia content transmitted by a server apparatus into another format. This enables this multimedia content to be played back on a client apparatus that is not capable of reading the original format. For example, the household 2 has a proxy server 50 programmed to:
compress and/or decompress a multimedia content,
change the format of a multimedia content, or
change the definition of a multimedia content.

In this embodiment, the terminal 20 also performs the role of a proxy server. Indeed, it is programmed to descramble a multimedia content recorded on another server apparatus before it is transmitted to a client apparatus.

The control apparatus is used to command the other apparatuses. In particular, it can be used to activate the reading of a multimedia content accessible from one of the server apparatuses on one of the client apparatuses. The control apparatus is not necessarily itself a client or server apparatus. By way of an illustration, the client apparatus here is a smart phone type of cellphone 52. In this particular case, the cellphone 52 is in addition a client apparatus or a server apparatus.

Advantageously, all the multimedia apparatuses connected to the network 4 are DLNA-compatible apparatuses.

FIG. 2 represents a table 60 of multimedia contents of a server apparatus. The table 60 associates the identifier IDeq of this server apparatus with identifiers IDc of the multimedia contents stored or received from a network external to the household by this apparatus.

In the example, the table 60 pertains to the computer 8. To this end, the table 60 comprises the identifier IDeq8 which identifies the computer 8. The identifier IDeq8 is associated with the following identifiers IDc: “AAA.mp3”, “BBB.mp3”, “CCC.mp3”. For example, these identifiers of multimedia contents correspond to the names of the files. Here, these files are songs in the mp3 format (MPEG-1/2 Audio Layer 3).

FIG. 3 represents a table of activity 70. The table 70 associates a state indicator IDetat with each identifier IDeq. The indicator IDetat indicates for example whether the server apparatus to which it pertains is connected to or disconnected from the network 4. In the table 70, the indicator IDetat takes the values IDetatC and IDetatD to indicate respectively the connected and disconnected states.

In the example, the table 70 comprises the indicators IDeq8 and IDeq20 identifying respectively the computer 8 and the terminal 20.

Advantageously if, at the end of a predetermined duration, a server apparatus is still disconnected, the identifier IDeq of this apparatus and the associated state indicator are erased from the table of activity 70. All the identifiers of the multimedia contents associated with this server apparatus are also erased from the contents log.

FIG. 4 represents a contents log 80. The contents log 80 contains, for each multimedia content accessible from server apparatus of the household 2, at least the following:
an identifier IDc of this multimedia content, and
the identifier IDeq of the server apparatus from which this multimedia content is accessible.

The contents log 80 may also contain other information associated with each multimedia content. For example, here the contents log 80 also comprises an indicator “P” indicating for each multimedia content whether or not it is protected. When the multimedia content is protected, the indicator “P” takes the value “Y”. Here, only the television channels “EEE” and “FFF” as well as the audio file “BBB.mp3” are protected. Here, the file “BBB.mp3” is scrambled with a set of control words decryptable by the processor 32.

To identify the most recent contents log, each contents log advantageously has a version number 72. The version number 72 is an alphanumerical string. Here, the version number is a number. This number is incremented whenever the contents log is updated.

Preferably, for each identifier IDc, the contents log has information elements on the multimedia contents such as its title, duration, etc. To simplify the Figure, these pieces of information have not been shown.

In the Figure, the contents log 80 comprises the identifiers IDeq8 and IDeq20. Here, the identifiers IDc associated with the identifier IDeq8 are “AAA.mp3”, “BBB.mp3”, and “CCC.mp3”. The identifiers IDc associated with the identifier IDeq20 are “DDD”, “EEE”, and “FFF”, “GGG”. For example, “DDD”, “EEE”, “FFF”, “GGG” are names of television channels. Finally, the version number of the contents log is the number “0000”.

For example, the contents log 80 is implemented in the form of an XML (Extensible Markup Language) file.

A method of accessing multimedia contents in the household 2 shall now be described with reference to FIG. 5.

At a preliminary phase 100, the user forms the network 4 within the household 2. To this end, at a step 102, the user connects the computer 8, the television set 40, the terminal 20 and the proxy server 50 to the router 5 by means of RJ45 cables.

At a step 106, the user sets up a WiFi connection between the camera 6, the HiFi system 42, the cellphone 52 and the router 5.

At a step 110, the apparatuses connected to the network 4 subscribe to predefined sub-network address, with the router 5. This address is here below called a “multicast address”. Thus, any message transmitted by an apparatus to this multicast address is received by all the apparatuses of the household 2.

At the end of the preliminary phase 100, the household 2 is as illustrated in FIG. 1.

During an election phase 108, a master apparatus is elected from among the multimedia apparatuses connected to the network 4. In this phase, all the apparatuses capable of fulfilling their referencing server function are in competition to become the master apparatus.

At a step 112, at least one of the apparatuses in competition, (called the “apparatus X1”) sends a message M to the multicast address. This message M contains the criteria for electing the master apparatus. Here, these criteria are:
the identity table of the apparatus X1,
the version number of the contents log stored in the recording carrier X1s of this apparatus, and
a number drawn randomly by this apparatus X1.

At a step 114, each apparatus in competition receives the message M.

In response, at a step 116, each apparatus determines whether it is more capable of becoming the master apparatus than the apparatus X1. To this end, the apparatus (called “apparatus X2”) compares its own characteristics with the election criteria received, according to a predefined set of rules. This set of rules typically comprises arithmetic and logic operations between these characteristics and the election criteria received. Advantageously, in order to prevent conflict, the set of predefined rules is identical for all the apparatuses in competition.

As an illustration, the set of rules is as follows:
Rule 1: if the version number of the contents log stored in the apparatus X1 is greater than the version number of the contents log stored in the apparatus X2, the apparatus X1 is more capable of becoming the master apparatus than the apparatus X2.
Rule 2: if the rule 1 is not sufficient to decide between the apparatuses X1 and X2, then the most capable apparatus belongs, by order of preference, to the category: computer, cellphone, camera, etc.
Rule 3: if the rules 1 and 2 are not sufficient to decide between the apparatuses X1 and X2, the most capable apparatus is the one with the highest computation capacity.
Rule 4: if the rules 1 to 3 are not sufficient to decide between the apparatuses X1 and X2, the most capable apparatus is the one with the highest bit rate.
Rule 5: if the rules 1 to 4 are not sufficient to decide between the apparatuses X1 and X2, the most capable apparatus is the one with a wire connection.
Rule 6: if the rules 1 to 5 are not sufficient to decide between the apparatuses X1 and X2, the most capable apparatus is the one which draws the greatest random number. This last rule makes it possible to decide between, for example, apparatuses X1 and X2 that are strictly identical.

At the end of this step 116, if the apparatus X2 establishes that the apparatus X1 is less capable than itself to become a master apparatus, then the apparatus X2 remains in competition to become the master apparatus. The apparatus X2 therefore continues to send its message M to the multicast address. Upon reception of this message, the apparatus X1 in turn determines that it is less capable than the apparatus X2 of fulfilling the role of master apparatus, and therefore stops sending its own message.

If the apparatus X2 determines that it is less capable than the apparatus X2 to become the master apparatus, the apparatus X2 stops sending its message M to the multicast address, the apparatus X2 is no longer in competition.

The steps 112, 114 and 116 are executed in a loop.

In parallel with the steps 112, 114 and 116, in a step 120, each apparatus in competition listens to the activity on the network in order to determine whether it is the last apparatus in competition. For example, each apparatus in competition measures the time that has elapsed since the last reception of a message M coming from another apparatus. When this time exceeds a predetermined duration, the apparatus deduces therefrom that it is the last apparatus in competition. In this case, the execution of the steps 112, 114 and 116 is interrupted and this apparatus is elected to become the master apparatus.

Here below in this description, it shall be assumed that, at the end of the steps 112 to 120, the computer 8 becomes the master apparatus.

At a step 124, the computer 8 sends a notification to the multicast address that it is the master apparatus. In response to this command, the other apparatuses do not relaunch a new procedure for electing a master apparatus and also know which is the apparatus that is the master apparatus of the household 2. In this notification, the computer 8 introduces the version number of its own contents log 80. This enables each of the other apparatuses to ascertain that it possesses an updated contents log. If this is not the case, it interrogates the computer 8 in order to obtain the most up-to-date contents log.

The step 124 is reiterated regularly. This especially enables the other apparatuses to detect any disconnection of the computer 8 from the network 4 and therefore to automatically relaunch the procedure for electing a new master apparatus.

At a step 126, each server apparatus subscribed to the multicast address regularly transmits a “keep alive” command to the computer 8 to indicate that it is connected to the network 4. Furthermore, each server apparatus sends the computer 8 its table 60 of multimedia contents.

At a step 128, the computer 8 builds a contents log 80 and a table of activity 70 out of the “keep alive” commands and the tables 60 received during the step 126. For example, the computer 8 concatenates the content of the different tables 60 received to form the table 80. Similarly, for each server apparatus identifier IDeq having sent a “Keep Alive” command, the computer 8 assigns the value IDetatC to the indicator IDetat in the table 70.

At a step 130, the computer transmits the contents log 80 and the table of activity 70 to all the apparatuses subscribed to the multicast address.

At a step 132, the multimedia apparatuses of the household 2, including the router 5, receive and store the contents log 80 and the table of activity 70 in their respective recording carrier.

This means that the household 2 is configured to be able to carry out one or more of the following phases:
the reading 140 of a multimedia content,
the elimination or addition 160 of a multimedia content,
the disconnection 200 of the master apparatus,
the connection 250 of an additional apparatus, and
the disconnection 270 of a server apparatus of multimedia content not fulfilling the referencing apparatus function.

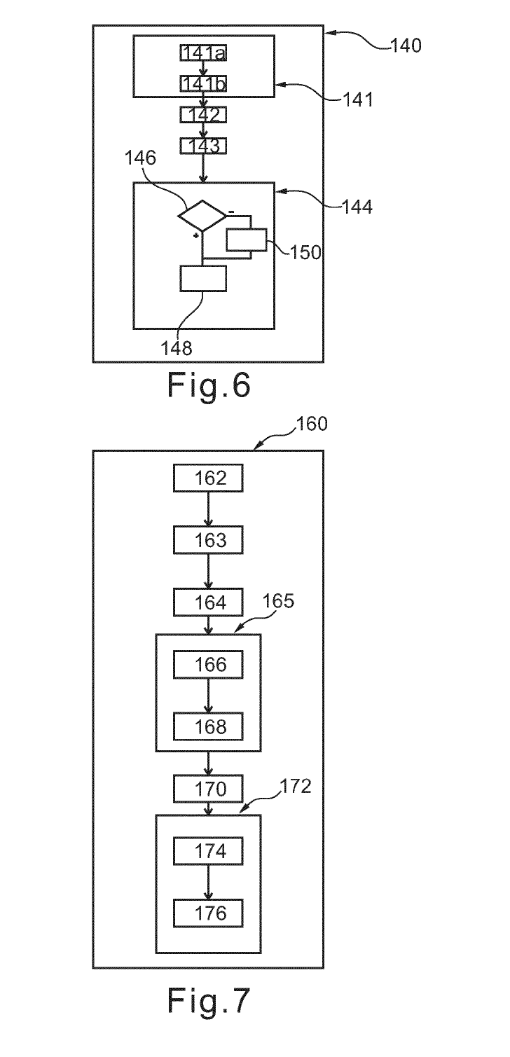

These different phases shall now be described one after the other with reference to FIGS. 6 to 10.

FIG. 6 is a flowchart of the phase 140. The phase 140 is described in the particular case where the cellphone 52 is used to activate the reading of the audiophonic content “AAA.mp3” on the Hi-Fi system 42.

At a step 141, the cellphone 52 acquires and processes a request for searching for a multimedia content within the household 2. For example, in response, it displays a graphic interface enabling the user to select a multimedia content of the household 2. Here, the cellphone displays only the multimedia contents immediately available in the household 2

To this end, at an operation 141a, the mobile telephone 52 creates a list of multimedia contents currently accessible in the household 2. For this purpose, it automatically filters the contents log received as a function of the data of the table of activity received to create a list containing solely the multimedia contents accessible from the server apparatuses currently connected to the network 4.

At an operation 141b, the list created is displayed on the cellphone 52. To simplify the use, only the identifiers IDc, the title and other payload information on the multimedia contents are displayed.

It is assumed here that the user selects the content “AAA.mp3” from this list.

At a step 142, the mobile telephone then presents a graphic interface enabling the user to select the multimedia apparatus on which the selected multimedia content must be played back. For example, at this step, the cellphone 52 builds a list of the client apparatuses currently connected to the network 4 using the received table of activity 70 and, preferably, capable of playing back the selected content. This list is displayed and the user selects the desired client apparatus. For example, he or she selects the Hi-Fi system 42. Then the cellphone 52 commands the Hi-Fi system 42 to activate the playback by itself of the content “AAA.mp3”. For example, the cellphone 52 sends a playback command to the Hi-Fi system 4 containing the “AAA.mp3” identifier by mean of a unicast link, and using the DLNA protocol.

In response to this command, at a step 143, the Hi-Fi system 42 makes a search, in the contents log stored in the recording carrier 42s, for the identifier IDeq of the multimedia apparatus from which the content “AAA.mp3” is accessible. In this particular case, the identifier found is IDeq8, i.e. the computer 8.

At a step 144, the Hi-Fi system 42 then sets up a unicast communications channel with the computer 8 and automatically activates the reading of the content “AAA.mp3” in streaming mode from this computer. The setting up of this communication link and the activation of the reading is done by using the DLNA protocol.

At the step 144, and more specifically during an operation 146, the Hi-Fi system 42 or the computer 8 ascertains that the format of the “AAA.mp3” content is compatible with the formats that can be played back with the Hi-Fi system 42. During this operation, a predetermined list of formats readable by the Hi-Fi system 42 is compared with the format of the “AAA.mp3” content.

If the answer is positive, the computer transmits the “AAA.mp3” content in streaming mode without any format conversion to the Hi-Fi system 42, which, in an operation 148, plays back this content as and when it receives it.

If the answer is negative, then, at a step 150, the computer 8 transmits the content “AAA.mp3” to the proxy server 50. The proxy server 50 converts the format of the multimedia content into a format that can be played back by the Hi-Fi system 42. For example, the proxy server, on the fly, converts the “AAA.mp3” content of the MPEG1/2 Audio Layer 3 (MPEG for=Moving Picture Expert Group) into the “wav” (WAVEform audio file format) format. After having been converted, the content is transmitted up to the Hi-Fi system 42 where the operation 148 is performed.

At the operation 146, the system 42 also ascertains that the content “AAA.mp3” is protected by means of the value of the indicator “P” associated with this content in the received table 80. If the answer is negative, the operation 148 is performed directly. If the response is positive, the multimedia content is transmitted to a proxy server capable of removing this protection. For example, here, the multimedia content is transmitted to the terminal 20 so that it descrambles the multimedia content before retransmitting it to the system 42. The scrambled multimedia content is preferably transmitted to the system 42 with a protection which the system is capable or removing locally. For example, the multimedia content is protected with DTCP (Digital Transmission Content Protection).

The phase 140 has been described in the particular case where the request for searching for a multimedia content is acquired by a control apparatus different from the client apparatus on which the multimedia content has to be played back. However, the acquisition of the search request can also be directly made by the client apparatus. In this case, the step 142 is for example omitted.

FIG. 7 is a flowchart of the phase 160 for eliminating or adding a multimedia content on a recording carrier Xs. Here, this phase is described in the particular case of the elimination of a content “HHH.mp4” initially recorded on the carrier 6s.

At a step 162, the content “HHH.mp4” is eliminated from the carrier 6s.

Immediately, in response, at a step 163, the camera 6 updates its table 60 of multimedia contents and eliminates the identifier “HHH.mp4” from this table.

Within the minute that follows, at a step 164, the camera 6 sends the master apparatus, i.e. the computer 8, an updating of its table 60 of multimedia contents.

In this example, an updating of a table of multimedia content is a partial table containing only the identifier of the server apparatus and the identifier of the added or eliminated multimedia content.

At a step 165, the computer 8 receives this update and in response updates the contents log 80 stored in the recording carrier 8s.

To this end, in an operation 166, the computer 8 eliminates the identifier “HHH.mp4” associated with the identifier IDeq6 from the contents log 80.

Then, in an operation 168, the computer 8 increments the version number of the contents log 80.

Then, at a step 170, the computer 8 transmits an update of the contents log to the multicast address. In this example, the transmitted update consists of a partial contents log comprising only the identifiers of the eliminated or added multimedia contents. Here, this partial contents log therefore contains the identifier “HHH.mp4”. Preferably this partial contents log also contains the identifier of the server apparatus on which this multimedia content is eliminated or added. This update also comprises the new version number of the contents log 80.

At a step 172, the apparatuses subscribed to the multicast address receive the update. Then, they update their local contents log 80 stored in their respective recording carrier Xs from this update. To this end, these apparatuses implement an operation 174 similar to the operation 166 described further above and an operation 176 during which the version number of their local contents log is replaced by the one received.

The steps to update the different contents logs following the addition of a multimedia content on one of the media Xs are identical except that the update transmitted by the master server contains instructions to add this multimedia content to each of the local contents logs.

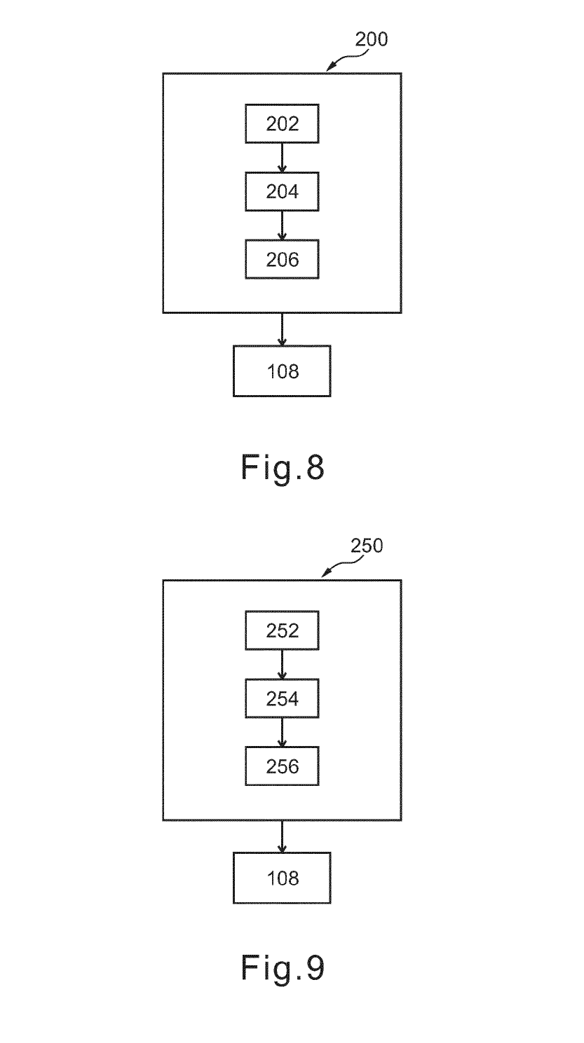

FIG. 8 shows a flowchart of the phase 200 for disconnecting the master apparatus from the household 2.

For example, at a step 202, the user disconnects the RJ45 cable connecting the computer 8 to the router 5.

At a step 204, at least one of the apparatuses connected to the network 4 detects the disconnection of the computer 8. For example, each apparatus measures the time that has elapsed since the reception of the last notification of the presence of a master apparatus connected to the network 4. If this time elapsed is greater than a predetermined threshold, it means that the computer 8 has been disconnected from the network 4. Indeed, as described here above, the step 124 for notifying the master apparatus is repeated at regular intervals. It is assumed here that the disconnection of the computer 8 is detected by the camera 6.

In response, at a step 206, the camera 6 transmits a command to the multicast address to activate the election of a new master apparatus within the household 2. For example, in response to this message, the method returns to the election phase 108.

FIG. 9 is a flowchart of the phase 250 for connecting a new multimedia apparatus to the network 4. The new apparatus is capable of fulfilling the referencing server function. The new apparatus can therefore have technical characteristics which make it the most capable, among all the apparatuses of the household 2, to fulfill the master apparatus function. The phase 250 is aimed at ensuring that the new apparatus has the possibility of swiftly becoming the master apparatus in place of the current master apparatus. Here, this phase 250 is described in the particular case where a new computer, identical to the computer 8, is connected to the network 4 by means of an RJ45 cable.

At a step 252, the user connects the new computer.

At a step 254, the new computer subscribes to the multicast address and disseminates a command on this address to report its presence on the network 4.

At a step 256, in response, the computer 8 transmits the latest version of the contents log 80 to the new computer. Then, the new computer transmits a command to the multicast address to trigger the election of a new master apparatus in the household 2. For example, in response, the method returns to the election phase 108.

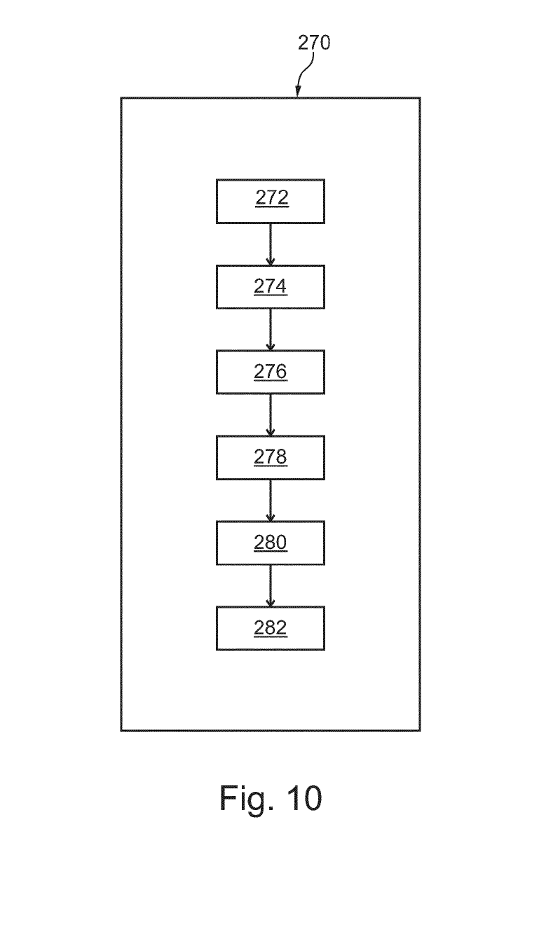

FIG. 10 is a flowchart of the phase 270 for disconnecting a server apparatus other than the master apparatus. This phase is described in the particular case where the terminal 20 is disconnected from the network 4.

At a step 272, the user disconnects the terminal 20 from the network 4. For example, the user unplugs the RJ45 cable connecting it to the router 5. Thus, the terminal 20 no longer transmits “Keep Alive” messages on the network 4.

At a step 274, the master apparatus, namely the computer 8, detects the absence of reception of a “Keep-Alive” message from the terminal 20 for a duration greater than a predetermined threshold. This establishes the fact that the terminal 20 is disconnected from the network 4.

In response, at a step 276, the computer 8 updates the table of activity 70 stored in the recording carrier 8s. More specifically, the computer 8 associates the value IDetatD with the identifier IDeq20.

At a step 278, the computer 8 transmits an update of the table of activity to the multicast address. In this example, this update consists of a partial table of activity containing the identifier IDeq of the server apparatus whose disconnection has been detected, namely the identifier IDeq20 and the new value of the associated state indicator IDetat, namely in this case the value IDetatD.

At a step 280, the apparatuses subscribed to the multicast address receive the updating of the table of activity.

In response, at a step 282, these apparatuses update their respective table of activity.

Many other embodiments are possible. For example, at the election of a master apparatus, many other election criteria can be used. For example, the occupation rate of an electronic computer Xc can be part of the election criteria.

When the master apparatus is disconnected from the network 4 and when no other apparatus of the household is capable of fulfilling the function of referencing server, then there is no longer any master apparatus in the household 2. In this situation, the client and command apparatuses can nevertheless use the last local contents log recorded in their respective carrier Xs. Furthermore, when an apparatus capable of fulfilling the function of referencing server is again connected to the network 4, it can download the contents log recorded in one of the other apparatuses of the household 2. For example, this apparatus downloads the contents log recorded in the memory 5c of the router 5. This enables this apparatus to reconstruct a contents log more rapidly.

As a variant, the master server adds resources other than multimedia contents to the contents log. For example, the contents log also has identifiers of computer resources liable to re-encode or modify a multimedia content. These other resources are also associated in the contents log with the identifiers of the apparatuses of the household 2 which they must address in order to implement these resources. Thus, a client apparatus can swiftly set up a unicast communications link with the required apparatus to execute the desired computer resource.

The contents log can also comprise, for each identifier IDc, the value of the identifier IDetat of the apparatus from which this content is accessible. In this case, the table of activity can be omitted.

The proxy servers can be omitted. In this case, the pieces of information contained in the contents log 80 to orient or not orient the stream of information from the server apparatus to the proxy server are omitted. For example, “P” can be omitted.

The saving of the contents log in the router 5 can be omitted.

The apparatuses such as the terminal 20 which gives access to multimedia contents situated outside the household 2 can be omitted.

The version number of the contents log may be a date on which the contents log was built.

At the phase 108, the predefined rules can be different for different apparatuses of the household 2. However, at the phase 108, the apparatuses may still be decided upon only on the basis of their random number drawn.

The updating of a contents log may take the form of a transmission, by the master apparatus, of a complete contents log containing, for each multimedia content accessible on the network, at least one identifier of this multimedia content and an identifier of the server apparatus of this multimedia content.

Similarly, the transmission of an update of a table of activity can take the form of a transmission of a complete table of activity.

The disconnection of an apparatus from the network 4 can be detected by methods other than the sending at regular intervals of the “Keep-Alive” message. For example, the master apparatus receives a notification from the router 5 informing it of the identifier of the multimedia apparatus that has just been disconnected.

Communications protocols other than the DLNA protocol can be used for communications between apparatuses.

The multimedia content is not necessarily transmitted in streaming mode. It can also be transmitted by gradual downloading or fully downloaded into a memory of the client apparatus before it can be played back by this client apparatus.

As a variant, the identifier of the client apparatus chosen to play back the multimedia content and the identifier of the server apparatus by means of which this multimedia content is accessible are transmitted to the master apparatus. The master apparatus then activates the server apparatus to set up the communications channel between this server apparatus and the selected client apparatus.

The unicast communications channel set up between the client and server apparatuses can pass or not pass through the master apparatus.

As a variant, the network 26 is the internet. In this case, the networks 5d and 26 can be the same.

The verification of the compatibility of the format of the selected multimedia content with the selected client apparatus can be done by the control apparatus.

The characteristic according to which the master apparatus transmits the contents log to all the apparatuses of the household so that they store it and can then search for the identifier of a server apparatus in their stored contents log can be implemented independently of the method for electing the master apparatus described here above. In particular, it can be implemented without any exchange of election criteria between the different apparatuses capable of fulfilling the function of referencing server.

1-11. (canceled)

12. A method for accessing multimedia contents within a household that comprises a home network, a server apparatus, connected to said home network, for service of multimedia contents, a client apparatus connected to said home network, said client apparatus being configured to play back a multimedia content accessible through said server apparatus connected to said home network, and a master apparatus selected from said group consisting of said server apparatus connected to said home network and said client apparatus connected to said home network, said master apparatus being configured to function as a referencing server, said method comprising causing said master apparatus to build a contents log, said contents log identifying multimedia contents stored or accessible throughout said household, and, for each multimedia content stored or accessible throughout said household, an identifier of said multimedia content and an identifier of a server apparatus associated with said multimedia content, seeking a multimedia content in said contents log, and setting up a unicast communications channel in said home network between said client apparatus and a server apparatus, an identifier of which is associated with said multimedia contents sought in said contents log, causing said client apparatus to receive, using said unicast communications channel, said multimedia content, and to play back said multimedia content, in response to connection of a new apparatus to said home network or disconnection of a master apparatus from said home network, causing different apparatuses capable of functioning as a referencing server to exchange election criteria for electing an apparatus to function as a referencing server, and based on said exchanged election criteria, electing a new master apparatus from among said apparatuses capable of functioning as a referencing server, wherein in response to election, said new master apparatus functions as a reference server.

13. The method of claim 12, further comprising causing said master apparatus to transmit said contents log to all client apparatuses of said household, causing each of said client apparatuses to receive and store said contents log, and causing one of said client apparatuses to respond to receiving a search request for searching for a multimedia content by searching for an identifier of a server apparatus through which said multimedia content sought is accessible in said contents log.

14. The method of claim 13, wherein said method further comprises causing a change in multimedia content accessible on a server apparatus, and in response to said change, causing said master apparatus to immediately update said contents log and to transmit information representative of said updated contents log to apparatuses of said household.

15. The method of claim 14, wherein said information representative of said updated contents consists of a partial contents log containing only an identifier of added or eliminated multimedia content and an identifier of a server apparatus to which said multimedia content has been added or from which said multimedia content has been eliminated.

16. The method of claim 12, wherein each contents log comprises a version number enabling identification, from among different contents logs, of a most recent contents log, and wherein election of said new master apparatus is restricted to electing only from among apparatuses that are both capable of functioning as a referencing server and that have stored thereon a most recent contents log.

17. The method of claim 12, wherein said election criteria includes computing capacity of an apparatus.

18. The method of claim 12, wherein said election criteria includes a type of connection of said apparatus to said network,

19. The method of claim 12, wherein said election criteria includes a version number of a contents log stored in said apparatus,

20. The method of claim 12, wherein said election criteria includes a number randomly drawn by said apparatus.

21. The method of claim 13, further comprising causing said master apparatus to build a table of activity containing, for each server apparatus of said household, a state indicator indicating whether said server apparatus is connected to or disconnected from said home network, causing said master apparatus to transmit said table of activity of all client apparatuses, and causing a client apparatus that has received said search request to use said table of activity to automatically filter results of said search request to eliminate, from said results, multimedia contents accessible only from a server disconnected from said home network.

22. A non-transitory information-recording carrier having encoded thereon software for accessing multimedia contents within a household that comprises a home network, a server apparatus, connected to said home network, for service of multimedia contents, a client apparatus connected to said home network, said client apparatus being configured to play back a multimedia content accessible through said server apparatus connected to said home network, and a master apparatus selected from the group consisting of said server apparatus connected to said home network and said client apparatus connected to said home network, said master apparatus being configured to function as a referencing server, said software comprising instructions for executing the method recited in claim 12.

23. An apparatus for implementing a method for accessing multimedia contents within a household, said apparatus comprising server apparatus, said server apparatus comprising an electronic computer programmed to build a contents log of said multimedia contents stored or accessible through different server apparatuses of said household, said contents log containing, for each multimedia content of a server apparatus of said household, an identifier of said multimedia content and an identifier of a server apparatus for said multimedia content, to set up a unicast communications channel in said home network with a client apparatus chosen to play back a sought multimedia content accessible from said server apparatus, to transmit said multimedia content sought by said unicast communications channel to enable a client apparatus to play back said multimedia content, in response to connection of a new apparatus to said home network, or disconnection of a master apparatus from said home network, to exchange, with different apparatuses, capable of functioning as a referencing server, criteria for electing an apparatus to fulfill said function of referencing server, to participate in election of a master apparatus from among said apparatuses capable of functioning as a referencing server based on said exchanged election criteria, and to implement, through said elected master apparatus, said referencing server function based on said exchanged election criteria.

24. The apparatus according to claim 23, wherein said server apparatus is DLNA-compatible.

24. An apparatus for implementing a method for accessing multimedia contents within a household via a home network, said apparatus comprising a client apparatus equipped with an electronic computer programmed to set up a unicast communications channel with a server apparatus identified as being associated with a multimedia content sought in a contents log of multimedia contents stored or accessible by one or more server apparatuses of said household, to receive said multimedia content through said unicast communications channel, to play back said multimedia content, in response to connection of a new apparatus to said home network, or disconnection, from said home network, of a master apparatus functioning as a referencing server, to exchange, with different apparatuses, capable of functioning as said referencing server, election criteria for electing an apparatus to functioning as a referencing server, based on said exchanged election criteria, to participate in election of a new master apparatus from among said different apparatuses capable of functioning as a referencing server, and in response to being elected as said new mater apparatus, to function as said referencing server.

25. The apparatus of claim 24, wherein said client apparatus is DLNA-compatible.
